(19) United States
(12) Patent Application Publication
(10) Pub. No.: US 2026/0320465 A1
(43) Pub. Date: Oct. 15, 2026

(54) METHOD FOR DETERMINING AN ERROR-CORRECTED EXPECTATION VALUE OF AN OBSERVABLE, METHOD FOR DETERMINING A GROUND-STATE ENERGY, HYBRID COMPUTER PLATFORM, ERROR REDUCTION ALGORITHM

(71) Applicant: Robert Bosch GmbH, Stuttgart (DE)

(72) Inventors: Johannes Selisko, Stuttgart (DE); Maximilian Amsler, Stuttgart (DE); Thomas Eckl, Leonberg (DE)

(21) Appl. No.: 19/382,580

(22) Filed: Nov. 7, 2025

(30) Foreign Application Priority Data
Nov. 19, 2024 (DE) 10 2024 133 882.2

(51) Int. Cl. G06N 10/70; G06N 10/20; G06N 10/40

(52) U.S. Cl. CPC G06N 10/70; G06N 10/20; G06N 10/40

(57) ABSTRACT

A method for determining an error-corrected expectation value of an observable of a quantum system by means of a classical computer. The method includes: providing a first expectation value of an observable, the first expectation value being dependent on a first distance measure, wherein the first distance measure indicates a spatial separation between a first qubit group and a second qubit group; providing at least a second expectation value of the observable, the second expectation value being dependent on a second distance measure; determining an adjusted fit function; determining an error-corrected expectation value of the observable by evaluating the adjusted fit function for the case that the distance measure assumes a value greater than the first distance measure and the second distance measure; providing the error-corrected expectation value.

### BACKGROUND INFORMATION

“Variational ansatz-based quantum simulation of imaginary time evolution” (McArdle et al., npj Quantum Information (2019) 5:75; doi.org/10.1038/s41534-019-0187-2) describes a method for determining a ground state of a many-body system that utilizes a hybrid system consisting of a quantum computer and a classical computer.

Currently available quantum computers, in particular based on superconducting circuits, show an increase in the available number of physical qubits. The currently available Osprey quantum computer chip from IBM comprises 433 qubits. This chip is even surpassed by IBM's Condor chip with 1121 qubits.

The currently available quantum computers are not fully error-corrected, resulting in errors and noise inherent in each quantum circuit executed on these quantum computers. Such quantum computers are therefore often referred to as NISQ (noisy intermediate scale quantum) technology. The currently available NISQ quantum computers are limited in their capabilities. Due to their limited size (low number of physical qubits) and inherent gate errors, such noisy NISQ computers only allow for the execution of short quantum circuits, i.e., shallow quantum circuits, and the results usually have rather large error bars. One example of such shallow quantum circuits is hybrid quantum-classical algorithms, such as the variational quantum eigensolver (VQE).

However, variational algorithms such as VQE cannot efficiently utilize this large number of qubits due to challenges resulting from the inherent noise.

### SUMMARY

Finding the ground state of a quantum-mechanical system is an important task in the context of atomistic material simulations and in the field of quantum chemistry. Many algorithms that use classical computers to address this problem have been developed in the past. However, the properties of materials cannot be calculated with sufficient accuracy on conventional high-performance computers.

An example of algorithms for solving quantum problems that use quantum computers is variational quantum algorithms, in particular variational quantum eigensolvers (VQE), which are based on a hybrid quantum-classical ansatz. They are used, for example, in determining a ground state of a quantum system (i.e., the lowest energy state). In this ansatz, a quantum state (e.g., a wave function) is encoded with a variational ansatz in a quantum circuit with variational parameters \vec{θₖ} and the corresponding expectation value Eₖ of the Hamiltonian (=measurement observable), which describes or approximates the quantum system, is measured. This measurement requires many (in the order of thousands of) individual measurements (shots) to obtain a statistically well-converged expectation value.

After an expectation value has been determined, a classical method is used to update the variational parameters \vec{θₖ}. For example, for the VQE, the parameters are updated along a downward direction in order to minimize the expectation value (energy) from the quantum circuit. The updated parameters \vec{θ}ₖ₊₁ are then returned to the quantum computer in order to obtain Eₖ₊₁. This iterative process is repeated until the converged ground-state energy Eₙ is obtained with its corresponding quantum state at iteration n. The quantum state of the iteration n is encoded in the variational parameters \vec{θₙ} and corresponds to the ground state of the quantum system or describes an approximation of the ground state.

The variational quantum eigensolver (VQE) is used in particular in quantum chemistry and material science. It is a hybrid algorithm that uses both classical computers and quantum computers. It is used in determining ground state energies and wave functions of complex quantum systems and provides insights into complex molecular and material behaviors. The VQE calculates the expectation value of a parameterized circuit and optimizes the parameters in order to minimize the energy. The global energy minimum is then assumed to be a good approximation of the ground-state energy. Optimization in the VQE becomes a challenge for larger systems since the optimizer can get stuck at local minima or at so-called barren plateaus with vanishing gradient. By means of a quantum computer, the expectation value of the system is determined with respect to an observable, for example the Hamiltonian of the system, and a classical optimizer is used to improve the parameters of the ansatz.

VQE combines the quantum calculation with classical optimization techniques. For this purpose, a Hamiltonian is provided, which describes properties of the quantum system investigated, e.g., the electron configuration of a molecular structure. For example, the Hamiltonian is represented as a linear combination of Pauli operators. A carefully chosen ansatz or parameterized quantum circuit approximates the ground state of the system. The core of VQE is its hybrid methodology. A classical optimizer is used to adjust or optimize the parameters of the ansatz. The goal is to minimize the expectation value of the energy of the Hamiltonian that is critical to achieving the ground state of the system.

In this interplay between quantum computer and classical computer, VQE iterates between measuring the expectation value of the Hamiltonian on the quantum computer and using classical algorithms to optimize the quantum circuit parameters (=variational parameters).

Another problem when using quantum algorithms for a large number of qubits arises from the increasing challenges with the system size. For VQE, for example, this is the number of variational parameters \vec{θₖ}, generally specified by a set of angles Θ, which scale unfavorably with the complexity of the ansatz and the number of qubits. Furthermore, the inherent noise of NISQ devices results in inefficient gradient-based optimizations.

In particular due to the aforementioned problems, as well as errors inherent in NISQ computers, and the limitations of classical optimization algorithms, such variational quantum-classical ansätze can be realized only for shallow quantum circuits and only for a few dozen variational parameters \vec{θₖ} and a low number of physical qubits. The performance of quantum computers comprising a large number of physical qubits, such as Osprey (433 physical qubits) or Condor (1121 physical qubits), therefore cannot be fully/efficiently utilized. In practice, only a small number of the physical qubits of the quantum computer is therefore used to encode the quantum circuit, and the rest of the qubits remains inactive during execution of the quantum circuit on the quantum computer.

In addition, another problem arises from the large number of shots (individual measurements) required to obtain statistically well-converged measurement results when executing quantum circuits.

The aforementioned problems substantially limit the potential of using an increasing number of physical qubits on quantum computers, in particular NISQ computers. One way to use more of these qubits is to encode multiple small quantum circuits in multiple clusters/qubit groups on a single quantum computer. These smaller quantum circuits may be identical so that this solution allows for parallelization across the number of individual measurements. In this way, many individual measurements can be carried out in parallel by executing these identical quantum circuits in a single pass of the quantum computer.

Alternatively, or in addition, these smaller quantum circuits may be different from one another, for example, in order to measure different observables in parallel, or to obtain gradients along different directions, as needed for VQE algorithms, for example.

Although this does not necessarily allow for the treatment of larger systems, it reduces the overall computation time for smaller systems.

The main problem with the aforementioned parallelization solutions is the occurrence of crosstalk between the qubit groups, resulting in correlated and non-local errors, even between different, independent clusters of quantum circuits encoded on a quantum computer. In order to address this source of error, it is proposed to separate the clusters on the quantum computer spatially in order to reduce crosstalk errors, which makes it possible to reduce the noise in the individual measurements on quantum computers with many, in particular more than 100 or more than 400, physical qubits with efficient computation time.

The present invention provides a method which makes it possible to
make use of a larger number of physical qubits of a quantum computer, and
parallelize the execution of quantum circuits, in particular of quantum circuits of a VQE, by ascertaining multiple clusters of physical qubits (=subsets of the physical qubits of the quantum computer; hereinafter also referred to as qubit groups), which clusters are each suitable for executing a quantum circuit.

Advantageously, the present invention allows more efficient use of quantum computers with a large number of, in particular more than 100 or more than 400, physical qubits by being able to execute multiple quantum circuits in parallel on the quantum computer and thus to increase the number of measurement results per pass with the number of clusters/qubit groups used or to decrease the number of required passes of the quantum computer for generating the same number of measurement results. In particular, the present invention makes it possible to reduce crosstalk between the qubit groups and thus to increase the reliability of the measurement results.

In other words, the present invention advantageously makes it possible to utilize a large number of qubits by allowing many smaller quantum circuits to be executed in parallel on a large quantum computer, for example in order to reduce the noise of the individual measurements. In particular, crosstalk errors are reduced by separating clusters of parallel-encoded small quantum circuits on the same quantum computer spatially and reducing crosstalk between the qubits by further methods.

A quantum circuit is a computational routine built from coherent quantum operations. Each horizontal line or wire in a quantum circuit represents a qubit, wherein the left end of the wire represents the original quantum data and the right represents the final quantum data, which are generated by the calculation of the quantum circuit. Operations on qubits are represented by boxes placed on these wires. Quantum gates are the elementary operations that a quantum computer can carry out on its qubits. They are comparable to electronic gates, which carry out the elementary operations of a classical computer. For quantum gates that operate on two qubits (2-qubit gates), an interaction between the physical qubits in question is required. For spin qubits, this can inter alia happen via the exchange interaction. Atoms in an ion trap can exchange photons, for example. For qubits based on superconducting circuits, the manipulation of these qubits can occur, for example, via the applied voltage, the magnetic field, or via the coupling to microwave resonators. Below, the term “quantum circuit” is understood to mean a quantum circuit for physical qubits. These quantum circuits may comprise further quantum gates, in particular SWAPs, in comparison to the quantum circuits for logical qubits, which further quantum gates may be supplemented in the quantum circuit for physical qubits in order to transport logical qubits to interacting physical qubits if they are involved in a joint quantum operation.

The present invention relates to a method for determining an error-corrected expectation value of an observable of a quantum system, to a method for determining a ground-state energy, to a hybrid computer platform, and to an error reduction algorithm.

The method of the present invention is based on a parallelization scheme in which the physical qubits of a quantum computer are divided into independent qubit groups (=clusters), and wherein the qubit groups are spaced apart from one another and encode independent quantum circuits. The spatial separation, which is achieved, for example, by arranging physical qubits that are not needed for executing the encoded quantum circuits, between the qubit groups, reduces the interaction between qubit groups.

Crosstalk errors can usually occur even between different, independent qubit groups, or the quantum circuits encoded therein. One advantage is that the method presented below avoids or at least reduces the occurrence of crosstalk, which leads to correlated and non-local errors, between the qubit groups. In particular, the method according the present invention thereby makes it possible to generate more reliable measurement results.

In particular, the present invention allows the available physical qubits of available quantum computers to be used efficiently. In particular, it allows the physical qubits of the qubit arrangement to be divided into qubit groups, which can each be used to execute a quantum circuit. In particular, possibly (but not necessarily) identical quantum circuits can thus be executed in parallel. This reduces the number of passes of the quantum computer for the same number of measurement results. This makes it possible to parallelize across shots (individual measurements), observables, or gradient descent directions for a VQE, resulting in a significant advantage in using a large number of physical qubits on NISQ computers.

This may be achieved with a method according to an example embodiment of the present invention for determining an error-corrected expectation value of an observable of a quantum system by means of a classical computer.

The term “quantum system” refers to physical systems in which manifestations of quantum mechanics are observable. Examples of such manifestations are quantization of energy or other observables, interference of particle waves, nonlocality, or quantum-mechanical tunneling. Quantum systems encompass the entire microscopic world, such as elementary particles and atoms, but also electrical conductors having dimensions in the nanometer range, semiconductors, large molecules, and certain materials whose macroscopic properties are determined by quantum-mechanical interaction on microscopic scales. The quantum system can in particular be described by a Hamiltonian. In quantum mechanics, the Hamiltonian of a system is an operator that describes the total energy of this system, including kinetic energy and potential energy. Its spectrum, the energy spectrum of the system, comprises the eigenvalues of the Hamiltonian, i.e., the energy eigenvalues. This is the set of possible results that can be achieved by measuring the total energy of the system.

In particular, a Hamiltonian of a quantum system can be used as an observable. This can in particular be a many-body Hamiltonian that describes or approximates a material. In particular, the method can be used to determine a ground-state energy of a material system.

An observable, in particular a quantum-mechanical observable, can be understood to mean a measured quantity and the operator associated therewith, which act in the state space, a Hilbert space. Examples of observables are the energy (the associated operator is the Hamiltonian of the quantum system), the location coordinates, the momentum coordinates, and the components of the spin of a particle. Observables assign values corresponding to the eigenvalue of the operator to the results of certain measurements. A key difference between classical quantities and quantum-mechanical observables is that some pairs of quantum-mechanical observables are not measurable simultaneously. If the operators of two quantum-mechanical observables do not commute, a measurement of the first operator changes the quantum state in a manner incompatible with the subsequent measurement of the second observable, and vice versa. Measured quantities that can be determined accurately at the same time are called commuting observables; they have the property that the order of their operators in the product can be swapped without changing the result. Observables that cannot be measured as accurately as desired at the same time are also referred to as complementary observables.

According to an example embodiment of the present invention, in order to determine the expectation value of an observable, a plurality of individual measurements is carried out on the quantum computer and, preferably on the classical computer, the expectation value of the observable is subsequently determined from these individual measurements. This requires a large number, for example in the order of several thousands, of individual measurements for statistical convergence in order to meet precision requirements, such as chemical accuracy in the application to quantum chemistry calculations. In order to give an order of magnitude of the number of measurements: It is commonly the case that a measurement of an observable with precision ε requires a number of measurements of order 1/ε². In particular, a single measurement comprises the following steps:
initializing at least a portion of the qubit group of a quantum computer with an initial quantum state,
applying a quantum circuit to the initial quantum state for preparing a quantum state for which the expectation value of the observable is to be measured, and
measuring the observable for this quantum state.

Quantum computers that are programmable by quantum circuits can in principle be constructed from any quantum technology that can realize single- and multi-qubit gate operations. Currently, architectures based on, for example, superconducting circuits, ion traps, semiconductor quantum dots, photons, and neutral atoms are actively being developed.

A quantum computer comprises a qubit arrangement, wherein the qubit arrangement comprises multiple physical qubits, which can preferably be provided with devices or units adapted appropriately to the technology with which the qubits are realized, for initializing (e.g., initializing the qubit in a basis state), for manipulating (e.g., applying 1-qubit and/or 2-qubit gates), and/or for reading the physical qubits.

As described above, crosstalk errors can in particular occur in a parallel execution of at least two quantum circuits on a qubit arrangement of a quantum computer. The present method in particular makes it possible to correct such an expectation value distorted by crosstalk errors, in order to determine an error-corrected expectation value.

Parallel execution of the quantum circuits in particular means that a number of individual measurements, which, for example, corresponds to the number of qubit groups in the case of identical quantum circuits, can be achieved in parallel with one control/call of the quantum computer, and an expectation value can thus be ascertained with fewer calls of the quantum computer in comparison to carrying out the individual measurements serially. In other words, during parallel execution, at least one quantum gate of the first quantum circuit is executed in a temporally overlapping manner with a quantum gate of the second quantum circuit.

The method according to an example embodiment of the present invention in particular comprises the following steps:
providing a first expectation value of an observable, the first expectation value being dependent on a first distance measure, wherein the first distance measure indicates a spatial separation between a first qubit group and a second qubit group, wherein one quantum circuit each was executed in parallel on the first qubit group and the second qubit group on a quantum computer for providing measurement results for determining the first expectation value;

In particular, the distance measure can be the value of the spatial distance, for example the distance of the geometric centers or centers of mass of the physical qubits of the qubit group. Alternatively, or in addition, the distance measure may comprise the value of the sum of the minimum distances between the clusters, taking into account qubit connectivity. Alternatively, or in addition, the quality (fidelities) of the qubits used in the individual qubit groups and their connectivity may be taken into account as additional parameters in the distance measure, in particular in order to avoid highly noisy qubits. In particular, the distance measure may be given in μm (microns) or nm (nanometers).

In particular, the term “qubit group” refers to a group or cluster of physical qubits of a qubit arrangement of a quantum computer, which are functionally separated, in particular also spatially separated, from the other physical qubits of the qubit arrangement. In particular, the physical qubits of the qubit group are suitable for executing a quantum circuit; in particular, the connectivity of the physical qubits of the qubit group is such that they are configured for executing the quantum circuit. Furthermore, interaction of the qubits with the further qubits of the qubit arrangement is reduced in comparison to the interaction with the members of the same qubit group.

The term “functional division” can in particular be understood to mean grouping a subset of physical qubits of the qubit arrangement of the quantum computer into a qubit group, which is suitable to execute a quantum circuit and which, in particular as a result of their spatial, but especially their functional separation, from the physical qubits of the qubit arrangement that do not belong to this qubit group, can be considered as a quantum computer independent of these qubits. A functional division into qubit groups in particular means that the physical qubits of different qubit groups preferably do not interact with one another. This is in particular achieved by spatial separation of the qubits. In particular, the qubit groups can be selected spaced apart from one another on the qubit arrangement. Spatial separation can be achieved, for example, in that physical qubits not associated with any of the qubit groups (i.e., not needed for executing the quantum circuits) are arranged between the qubit groups and thus form a type of boundary of the qubit groups. The term “functional” here in particular means that the physical qubits of a qubit group are needed, in particular, for the execution of the quantum circuit encoded on the qubit group and thus have been grouped for fulfilling a common function. According to an example embodiment of the present invention, a division into at least two qubit groups, i.e., in particular also more than two or more than three qubit groups, is provided. The measurement results of the individual measurements used to determine the first expectation value are in particular generated by a quantum computer. In particular, they are also provided by the quantum computer. The first expectation value is in particular determined on a classical computer from the measurement results of the individual measurements.
providing at least a second expectation value of the observable, the second expectation value being dependent on a second distance measure, wherein the second distance measure indicates a spatial separation between the first qubit group and the second qubit group, wherein one quantum circuit each was executed in parallel on the first qubit group and the second qubit group on the quantum computer for providing measurement results for determining the second expectation value; the measurement results of the individual measurements used to determine the second expectation value are in particular generated by a quantum computer. In particular, they are also provided by the quantum computer. The second expectation value is in particular determined on a classical computer from the measurement results of the individual measurements.
determining an adjusted fit function with the steps of:
providing a fit function, which comprises at least one fit parameter and depends on the distance measure; curve adjustment, also called fitting, is a technique by which an attempt is made to best fit a given mathematical model function, the fit function, to data points, here the distance-measure-dependent expectation values. The simplest case of a fit function is probably the determination of a best-fit straight line, wherein the coefficients k and l of the first-degree polynomial

f(dᵢₙᵥ,k,l)=kdᵢₙᵥ+l

In particular, the independent variable dᵢₙᵥ can be the inverse of a distance measure d. The fit parameters k and l can be determined such that the sum of the distance squares of the data points assumes the lowest possible value.
adjusting the fit parameters of the fit function to the first expectation value and the second expectation value;
determining an error-corrected expectation value of the observable by evaluating the adjusted fit function for the case that the distance measure assumes a value greater than the first distance measure and greater than the second distance measure; this step is based on the consideration that crosstalk errors are distance-dependent and the expectation is that crosstalk errors between qubit groups decrease with increasing spacing between the qubit groups so that an extrapolation toward a distance measure that is greater than the distance measures of the expectation values used for the fit already causes a reduction in the crosstalk errors. In particular, the extrapolation can be toward a fictitious, infinite distance measure. In the formulation of the fit function as a function of the inverse distance metric, the expectation values at different distance measures d are plotted over the inverse distance measures

$${d}_{inv} = \frac{1}{d} .$$

This extrapolation corresponds to an evaluation of the fit function

$${d}_{inv} = \frac{1}{d} \to 0 ,$$

i.e., when the inverse distance metric tends toward zero or the distance metric approaches infinity.
providing the error-corrected expectation value. The provision can in particular be carried out by data transmission or wireless or wired data transfer, by display, by output or by storage, for example in a database.

An advantage of the method is that this method makes it possible to execute multiple quantum circuits (identical, at least partially identical and/or different quantum circuits) on an arrangement of physical qubits of a quantum computer, wherein the hardware-specific characteristics, such as a connectivity of the physical qubits of the qubit arrangement, their particular quality, requirements, etc., which result from the quantum circuits, can be taken into account in order to reduce crosstalk errors.

In particular, the method of an example embodiment of the present invention comprises providing more than two expectation values for different distance measures and taking them into account when determining the fit parameters of the fit function.

The method is based on a mitigation scheme, which can also be referred to as “infinite distance extrapolation.” In this case, the clusters (=qubit groups) are arranged at different, in particular increasing, distances, which are characterized by the distance measure, from one another for determining expectation values in order to evaluate the effect of crosstalk and to correct the result based on an extrapolated error term in the limit of the infinite cluster distance.

According to one example embodiment of the present invention, the distance measure is given by a, in particular minimum, shortest path distance between qubit groups. The shortest path distance is reduced to the Manhattan distance, or Manhattan metric, in a square or cubic lattice. The latter is a metric in which the distance between two points is defined as the sum of the absolute differences of their individual coordinates. The Manhattan norm d(\vec{q}, \vec{p}) between two points \vec{q}=(q₁, q₂, . . . , qₙ) and \vec{q}=(p₁, p₂, . . . , pₙ) is defined as

$$d ( \vec{q} , \vec{p} ) = {\sum }_{i = 1}^{n} \vert {q}_{i} - {p}_{i} \vert$$

If the qubit connectivity for some qubits deviates from a square/cubic lattice, the Manhattan norm may need to be adjusted accordingly by taking into account the missing connectivities, either through a breadth-first or a depth-first search algorithm. In turn, the minimum distances dₘᵢₙ(cₗ, cₖ) with reduced connectivity can be derived therefrom as a sum of the single-path lengths. For the most general case, physical qubits and their connectivity can be represented as an undirected graph, as a result of which various shortest path algorithms, such as Dijkstra's algorithm, can generally be used to determine dₘᵢₙ(cₗ, cₖ).

According to one example embodiment of the present invention, the distance measure is given as a Euclidean distance between the geometric centers between qubit groups.

According to one example embodiment of the present invention, when determining the error-corrected expectation value, the adjusted fit function is evaluated for the case that the distance measure assumes the value infinity. An advantage is that, in the limiting case of an infinite distance between the qubit groups, crosstalk errors are no longer present.

According to one example embodiment of the present invention, providing the first expectation value and the second expectation value comprises the following steps:
providing the first distance measure and at least the second distance measure; in particular, this step also includes providing more than two distance measures
performing the following steps for the first distance measure and the second distance measure:
functionally dividing a qubit arrangement of the quantum computer into a first qubit group and at least a second qubit group, the spatial separation of which is determined by the specified distance measure;
providing a mapping of the quantum circuit to the first qubit group and the second qubit group
performing the following steps in parallel on the quantum computer:
initializing the first qubit group and executing the quantum circuit by means of the first qubit group for generating first measurement results; and
initializing the second qubit group and executing the quantum circuit by means of the second qubit group for generating second measurement results;
determining the expectation value of the observable by using the first and second measurement results, the expectation value being dependent on the specified distance measure. In particular, multiple individual measurements, in particular several thousands of individual measurements, are performed by means of the quantum computer for each distance measure, and an expectation value per distance measure is determined from this plurality of individual measurements for each distance measure. The latter is preferably carried out on the classical computer.

In particular, according to an example embodiment of the present invention, providing a mapping of the quantum circuit to the qubit group comprises assigning the qubits listed in the quantum circuit to the physical qubits of the quantum computer. Furthermore, the provision can comprise an initial quantum state for the particular qubit group, as well as gate parameters for controlling the quantum gates for executing the quantum circuit. The provision can in particular be carried out by input, by data transmission or wireless or wired data transfer, or by retrieval, for example from a database.

Initializing the qubit groups means in particular preparing an initial state for each qubit group and providing control signals, based on the gate parameters for controlling the quantum gates as a function of the gate parameters when executing the quantum circuit on the quantum computer; for example, if the quantum gates are designed as rotation gates, which cause, for example, a one-qubit rotation by an angle about one of the axes X, Y, or Z of the Bloch sphere, the angle is equal to the gate parameter. The control signals depend on the technology of the quantum computer used. For qubits based on superconducting circuits, the qubits can be manipulated, for example, via the applied voltage, the magnetic field, or via the coupling to microwave resonators so that the control signals are configured, for example, for setting the magnetic field and/or for setting the frequency of the microwave resonators. In particular, the control signals can comprise electrical signals. The expectation value obtained benefits from the fact that the crosstalk occurs at different positions in the quantum circuits and can therefore cancel out. An improved result, in particular provided with reduced crosstalk errors, can thus be achieved in comparison to expectation values determined from measurement results without the insertion of delay values.

For example, preparing a quantum state may be carried out by applying a quantum circuit to an initial quantum state on the quantum computer. When initializing the quantum computer, in other words when setting the initial quantum state, the qubits of the quantum computer are brought into the initial quantum state. For example, all qubits are brought to the state |0> or all qubits are brought to the state |1>. Alternatively, the qubits are brought into an initial qubit state sequence, i.e., a first number of qubits is brought into the state |0> and a second number of qubits is brought into the state |1>. An example of a qubit state sequence of five qubits in which all qubits are in the state |0> is: 00000. Initializing furthermore comprises providing control signals, which are in particular specified by the quantum circuit for preparing the quantum state for which the observable expectation value is to be determined. When preparing the quantum state, the quantum gates manipulate the states of the qubits of the quantum computer, according to the quantum gates provided in the quantum circuit so that the prepared quantum state is present after executing the quantum circuit.

According to one example embodiment of the present invention, the fit function comprises a linear function, a polynomial function, and/or an exponential function. An example of a polynomial fit function is:

$$f ( {d}_{inv} , {p}_{1} , {p}_{2} , … , {p}_{k} ) = {p}_{1} + {p}_{2} {d}_{inv} + {p}_{3} {d}_{inv}^{2} + … + {p}_{k} {d}_{inv}^{k - 1}$$

where dᵢₙᵥ=dᵢₙᵥ(d) is a function of the distance measure d, p₁, . . . , pₖ are the fit parameters, and k is the number of expectation values for different distance measures (in particular, k>1).

According to one example embodiment of the present invention, the fit function is a function of the inverse distance measure, i.e.,

$${d}_{inv} = \frac{1}{d} .$$

In other words, the fit function is expressed as a function of the inverse distance:

$$f ( \frac{1}{d} ) .$$

According to one example embodiment of the present invention, the fit function is expressed as a function of the inverse distance

$$f ( \frac{1}{d} ) ,$$

and, when determining the error-corrected distance: expectation value, the adjusted fit function is evaluated for the case that the inverse distance measure assumes the value zero

$$( f ( \frac{1}{∞} ) \to f ( 0 ) ) .$$

In particular, the expectation value is approximated by f(0) for an infinite distance measure.

Furthermore, according to the present invention, a method for determining a ground-state energy of a quantum system is provided, wherein the method for reducing errors in determining a Hamiltonian, in particular the expectation value of the Hamiltonian of the quantum system, is used in a ground state of the quantum system in order to obtain an error-reduced ground-state energy.

In particular, the associated ground-state energy can be output and/or stored. The output may, for example, be carried out by transmission to a hybrid computer platform, a classical computer, a quantum computer, a cloud, and/or a display device. Alternatively, or in addition, the output may be used as input of a further algorithm, in particular an algorithm for material simulation, in which the quantum system is investigated for certain material properties.

Finding the ground state of a quantum-mechanical system is an important task in the context of atomistic material simulations and in the field of quantum chemistry.

According to one example embodiment of the present invention, the quantum system whose ground-state energy is to be determined is a many-body system, which may be described, for example, by a Hubbard Hamiltonian. The Hubbard model is a simplified model of a solid. It describes the behavior of electrons in a lattice assumed to be rigid. The repulsive Coulomb forces are only taken into account for electrons that are at the same lattice site. The proportion of kinetic energy of the electrons is modeled by an overlap integral that comes from the tight-binding model. Some examples of quantum systems that can be described by a Hubbard Hamiltonian are highly correlated fermion systems, transition metals, mobile electron systems (e.g., ferromagnetism, antiferromagnetism, ferrimagnetism), x electron systems in quantum chemistry. One advantage is that the method thus accelerates the development and investigation of new materials and in part also makes them possible in the first place. Furthermore, properties of these new materials can thus be better adapted to the particular application.

The aforementioned advantages also arise for the use of the aforementioned methods for material simulation, wherein a Hamiltonian of the quantum system is a many-body Hamiltonian describing the material to be simulated.

A hybrid computer platform, which is an example of a noisy quantum computer platform, comprises a classical computer and a quantum computer for executing a quantum circuit, which are adapted to perform the steps of the methods described above and/or to implement the use of the method for material simulation, has the advantage of being usable particularly efficiently for material simulation. Adapting can in particular be understood to mean, for example, that the hardware of the quantum computer can be tuned to the quantum circuit so that the mapping of the logical qubits of the quantum circuit to the physical qubits of the quantum computer is possible and preferably requires only the addition of a lowest possible to vanishing number of additional SWAP operations, which ensures the interaction of the physical qubits occupied by the logical qubits, when performing, for example, 2-gate operations. In particular, the hardware of the quantum computer can be selected based on the provided quantum circuit and can thus allow for an execution of the method that is even more efficient and less prone to noise. In particular, the hybrid computer platform can be understood to comprise at least one classical computer and at least one quantum computer. Preferably, it comprises a cloud computing platform, which the classical computer can access so that it can in particular retrieve the measurement results of the quantum computer from there. In particular, the quantum computer has more than 400 physical qubits. In particular, the quantum computer is configured to execute at least two or more than two quantum circuits in parallel when called.

According to one example embodiment of the present invention, a NISQ computer is used as a quantum computer.

Furthermore, an error reduction algorithm is provided according to the present invention, which causes a hybrid computer platform comprising a classical computer and a quantum computer for executing a quantum circuit to perform at least one of the methods described above.

A computer-readable storage medium which stores the error reduction algorithm of the present invention, which is an implementation of the method described above, can be controlled, in particular by the quantum computer and/or the classical computer, to provide the error reduction algorithm of the present invention.

### BRIEF DESCRIPTION OF THE DRAWINGS

Exemplary embodiments of the present invention are shown in the figures and explained in more detail in the following description. Identical reference signs in the figures denote identical or functionally identical elements.

FIG. 1 shows a sketch of a connectivity graph for the physical qubits of a 127-qubit quantum computer with qubit groups drawn in, according to a first exemplary embodiment of the present invention.

FIG. 2 shows a sketch of a connectivity graph for the physical qubits of a 127-qubit quantum computer with qubit groups drawn in, according to a second exemplary embodiment of the present invention.

FIG. 3 shows a flowchart of a method for determining an error-corrected expectation value of an observable of a quantum system, according to an example embodiment of the present invention.

FIG. 4 shows a schematic representation of a hybrid computer platform, according to an example embodiment of the present invention.

### DETAILED DESCRIPTION OF EXAMPLE EMBODIMENTS

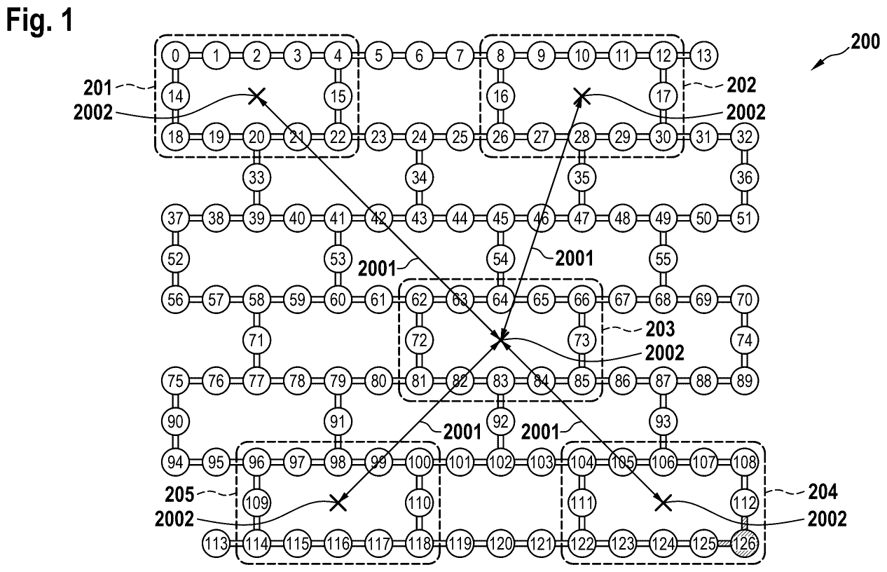

FIG. 1 shows a sketch of a hardware-specific connectivity graph 200 of the physical qubits 0, . . . , 126 of a quantum computer. In this exemplary embodiment, the physical qubits 0, . . . , 126 are arranged in a heavy-hex lattice, which is used, for example, on IBM's superconducting quantum computer (127-qubit Eagle processor). The physical qubits have been numbered sequentially by rows here. The connectivity graph associated with a qubit arrangement of the quantum computer comprises a total of 127 physical qubits 0, . . . , 126, which are represented as circles or nodes in the sketch and are numbered sequentially in order to be able to identify them. Nodes of physical qubits 0, . . . , 126 configured to interact with one another are in particular connected to one another by edges in the hardware-specific connectivity graph. In other words, the connectivity graph 200 provides information on the number and connectivity of the physical qubits 0, . . . , 126.

In this exemplary embodiment, a quantum circuit having twelve physical qubits is to be implemented. In principle, such a quantum circuit could be implemented ten times in parallel on the 127-qubit Eagle processor, which would result in n=10 clusters (=qubit groups) in the connectivity graph. However, such a dense aggregation of qubit groups would result in significant crosstalk errors. A smaller number of qubit groups to be implemented is therefore selected, namely, five. This can reduce crosstalk between the qubit groups 201, 202, 203, 204, 205. There are many different ways in which these clusters can be represented in the connectivity graph.

In this exemplary embodiment, five qubit groups 201, 202, 203, 204, 205 were positioned on the physical qubits 0, . . . , 126 of the quantum computer as follows:

The first qubit group 201 comprises the physical qubits numbered 0, 1, 2, 3, 4, 14, 15, 18, 19, 20, 21, 22. The second qubit group 202 comprises the physical qubits numbered 8, 9, 10, 11, 12, 16, 17, 26, 27, 28, 29, 30.

The third qubit group 203 comprises the physical qubits numbered 62, 63, 64, 65, 66, 72, 73, 81, 82, 83, 84, 85.

The fourth qubit group 205 comprises the physical qubits numbered 96, 97, 98, 99, 100, 109, 110, 114, 115, 116, 117, 118.

The fifth qubit group 205 comprises the physical qubits numbered 104, 105, 106, 107, 108, 111, 112, 122, 123, 124, 125, 126.

In total, each qubit group 201, 202, 203, 204, 205 comprises the same number of physical qubits 0, . . . , 126, namely, twelve in each case. Furthermore, the independent qubit groups have the same structure in terms of connectivity of the comprised physical qubits 0, . . . , 126. At the centers of the qubit groups 201, 202, 203, 204, 205, the geometric center 2002 of the respective qubit group 201, 202, 203, 204, 205 is marked, wherein some distance measures 2001 of the geometric centers, the Euclidean distances (=L2 distances) here, are drawn in by way of example.

Each of these qubit groups can execute independent quantum circuits in parallel so that, when the quantum computer in FIG. 1 is called, five individual measurements of the observable can be carried out and measurement results from five individual measurements can thus be provided.

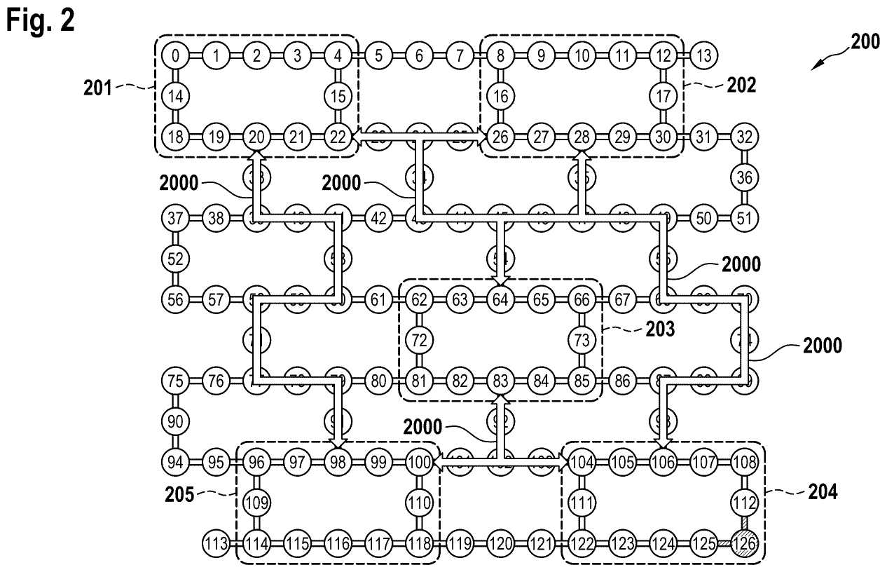

FIG. 2 differs from FIG. 1 only in the distance measure. In this exemplary embodiment, the shortest path metrics 2000 are drawn between the qubit groups 201, 202, 203, 204, 205.

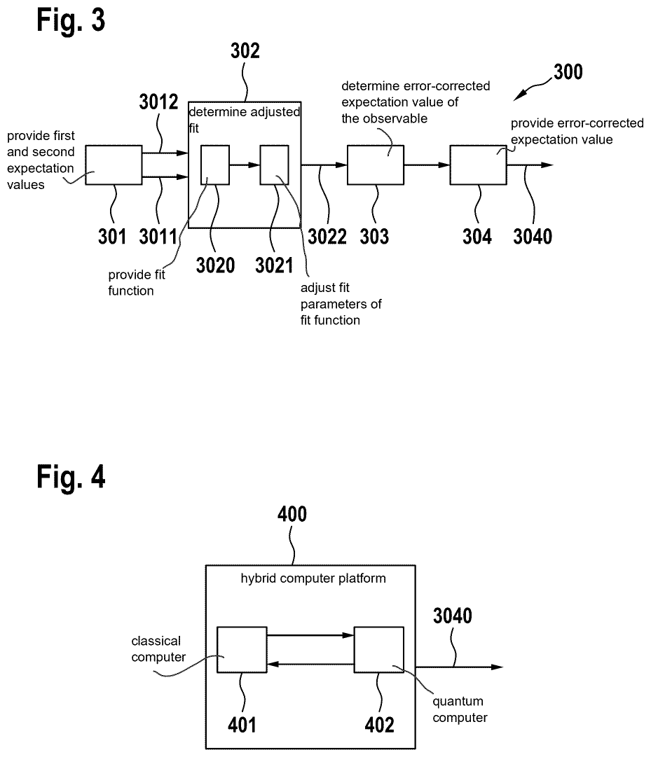

FIG. 3 shows a flowchart of a method 300 for determining an error-corrected expectation value of an observable of a quantum system by means of a classical computer, comprising the following steps:
providing 301 a first expectation value 3011 of an observable, the first expectation value being dependent on a first distance measure 2000, 2001, wherein the first distance measure 2000, 2001 indicates a spatial separation between a first qubit group 201 and a second qubit group 202, wherein one quantum circuit each was executed in parallel on the first qubit group 201 and the second qubit group 202 on a quantum computer for providing measurement results for determining the first expectation value;
providing 301 at least a second expectation value 3012 of an observable, the second expectation value being dependent on a second distance measure 2000, 2001, wherein the second distance measure 2000, 2001 indicates a spatial separation between the first qubit group and the second qubit group, wherein one quantum circuit each was executed in parallel on the first qubit group and the second qubit group on the quantum computer for providing measurement results for determining the second expectation value;
determining 302 an adjusted fit function 3022 with the steps of:
providing 3020 a fit function which comprises at least one fit parameter and depends on the distance measure 2000, 2001;
adjusting 3021 the fit parameters of the fit function to the first expectation value 3011 and the second expectation value 3012;
determining 303 an error-corrected expectation value of the observable by evaluating the adjusted fit function 3022 for the case that the distance measure 2000, 2001 assumes a value greater than the first distance measure 2000, 2001 and greater than the second distance measure 2000, 2001;
providing 304 the error-corrected expectation value 3040.

In particular, providing the first expectation value 3011 and the second expectation value 3012 can comprise the following steps:
providing the first distance measure and at least the second distance measure;
performing the following steps for the first distance measure:
functionally dividing a qubit arrangement of the quantum computer into a first qubit group and at least a second qubit group, the spatial separation of which is determined by the first distance measure;
providing a mapping of the quantum circuit to the first qubit group and the second qubit group
performing the following steps in parallel on the quantum computer:
initializing the first qubit group (201) and executing the quantum circuit by means of the first qubit group for generating (404) first measurement results; and
initializing the second qubit group (202) and executing the quantum circuit by means of the second qubit group for generating second measurement results;
determining the expectation value of the observable by using the first and second measurement results, the expectation value being dependent on the first distance measure.
performing the following steps for the second distance measure:
functionally dividing a qubit arrangement of the quantum computer into a first qubit group and at least a second qubit group, the spatial separation of which is determined by the second distance measure;
providing a mapping of the quantum circuit to the first qubit group and the second qubit group
performing the following steps in parallel on the quantum computer:
initializing the first qubit group (201) and executing the quantum circuit by means of the first qubit group for generating (404) first measurement results; and
initializing the second qubit group (202) and executing the quantum circuit by means of the second qubit group for generating second measurement results;
determining the expectation value of the observable by using the first and second measurement results, the expectation value being dependent on the second distance measure.
performing the steps described above for further distance measures different from the first and second distance measures.

FIG. 4 is a schematic representation of a hybrid computer platform 400, which is an example of a noisy quantum computer platform on which the method 400, as shown by way of example in FIG. 3, can be performed. The hybrid computer platform 400 comprises the classical computer 501 and the quantum computer 402, which are adapted to perform the method 400, as shown by way of example in FIG. 3 and described above. In particular, the hybrid computer platform outputs the error-corrected expectation value 3040, for example, the ground-state energy of a quantum system.

1-14. (canceled)

15. A method for determining an error-corrected expectation value of an observable of a quantum system using a classical computer, comprising the following steps:
providing a first expectation value of an observable, the first expectation value being dependent on a first distance measure, wherein the first distance measure indicates a spatial separation between a first qubit group and a second qubit group, wherein respective quantum circuits were executed in parallel on the first qubit group and on the second qubit group on a quantum computer for providing measurement results for determining the first expectation value;
providing at least a second expectation value of the observable, the second expectation value being dependent on a second distance measure, wherein the second distance measure indicates a spatial separation between the first qubit group and the second qubit group, wherein respective quantum circuits were executed in parallel on the first qubit group and on the second qubit group on the quantum computer for providing measurement results for determining the second expectation value;
determining an adjusted fit function by performing:
providing a fit function which includes at least one fit parameter and depends on a distance measure,
adjusting the at least one fit parameter of the fit function to the first expectation value and the second expectation value;
determining an error-corrected expectation value of the observable by evaluating the adjusted fit function for the case that the distance measure assumes a value greater than the first distance measure and greater than the second distance measure;
providing the error-corrected expectation value.

16. The method according to claim 15, wherein, when determining the error-corrected expectation value, the adjusted fit function is evaluated for the case that the distance measure assumes the value infinity.

17. The method according to claim 15, wherein providing the first expectation value and providing the second expectation value includes the following steps:
providing the first distance measure and at least the second distance measure;
performing the following steps for each respective distance measure of the first distance measure and the second distance measure:
functionally dividing a qubit arrangement of the quantum computer into the first qubit group and at least the second qubit group, the spatial separation of which is determined by the respective distance measure,
providing a respective mapping of the respective quantum circuits to the first qubit group and the second qubit group, respectively,
performing the following steps in parallel on the quantum computer:
initializing the first qubit group and executing the respective quantum circuit using the first qubit group for generating first measurement results, and
initializing the second qubit group and executing the respective quantum circuit using the second qubit group for generating second measurement results, and
determining the first or second expectation value of the observable by using the first or second measurement results, the first or second expectation value being dependent on the respective distance measure.

18. The method according to claim 15, wherein the fit function includes a linear function and/or a polynomial function and/or an exponential function.

19. The method according to claim 15, wherein the fit function is a function of an inverse of the distance measure.

20. The method according to claim 19, wherein, when determining the error-corrected expectation value, the adjusted fit function is evaluated for the case that the inverse of the distance measure assumes a value of zero.

21. The method according to claim 15, wherein the method is used for determining a ground-state energy of a quantum system, wherein the steps of the method are used for reducing errors in determining an expectation value of a Hamiltonian of the quantum system in a ground state of the quantum system, to obtain an error-reduced ground-state energy.

22. The method according to claim 15, wherein the quantum system is described by a many-body Hamiltonian of a material.

23. The method according to claim 21, wherein the Hamiltonian of the quantum system is a Hamiltonian for a Hubbard model.

24. The method according to claim 15, wherein the method is used for material simulation, wherein a Hamiltonian of the quantum system is a many-body Hamiltonian describing the material to be simulated.

25. A hybrid computer platform, comprising:
a classical computer; and
a quantum computer for executing a quantum circuit;
wherein the classical computer and the quantum computer are adapted to perform a method for determining an error-corrected expectation value of an observable of the quantum computer using the classical computer, the method including the following steps:
providing a first expectation value of an observable, the first expectation value being dependent on a first distance measure, wherein the first distance measure indicates a spatial separation between a first qubit group and a second qubit group, wherein respective quantum circuits were executed in parallel on the first qubit group and on the second qubit group on the quantum computer for providing measurement results for determining the first expectation value;
providing at least a second expectation value of the observable, the second expectation value being dependent on a second distance measure, wherein the second distance measure indicates a spatial separation between the first qubit group and the second qubit group, wherein respective quantum circuits were executed in parallel on the first qubit group and on the second qubit group on the quantum computer for providing measurement results for determining the second expectation value;
determining an adjusted fit function by performing:
providing a fit function which includes at least one fit parameter and depends on a distance measure,
adjusting the at least one fit parameter of the fit function to the first expectation value and the second expectation value;
determining an error-corrected expectation value of the observable by evaluating the adjusted fit function for the case that the distance measure assumes a value greater than the first distance measure and greater than the second distance measure;
providing the error-corrected expectation value.

26. The hybrid computer platform according to claim 25, wherein the quantum computer is a NISQ computer.

27. A non-transitory computer-readable storage medium on which is stored an error reduction algorithm, the error reduction algorithm, when executed by a hybrid computer platform including a classical computer and a quantum computer for executing a quantum circuit, causing the hybrid computer platform to perform a method for determining an error-corrected expectation value of an observable of the quantum computer using the classical computer, the method including the following steps:
providing a first expectation value of an observable, the first expectation value being dependent on a first distance measure, wherein the first distance measure indicates a spatial separation between a first qubit group and a second qubit group, wherein respective quantum circuits were executed in parallel on the first qubit group and on the second qubit group on the quantum computer for providing measurement results for determining the first expectation value;
providing at least a second expectation value of the observable, the second expectation value being dependent on a second distance measure, wherein the second distance measure indicates a spatial separation between the first qubit group and the second qubit group, wherein respective quantum circuits were executed in parallel on the first qubit group and on the second qubit group on the quantum computer for providing measurement results for determining the second expectation value;
determining an adjusted fit function by performing:
providing a fit function which includes at least one fit parameter and depends on a distance measure,
adjusting the at least one fit parameter of the fit function to the first expectation value and the second expectation value;
determining an error-corrected expectation value of the observable by evaluating the adjusted fit function for the case that the distance measure assumes a value greater than the first distance measure and greater than the second distance measure;
providing the error-corrected expectation value.
